(19) United States
(12) Patent Application Publication
(10) Pub. No.: US 2005/0124446 A1
(43) Pub. Date: Jun. 9, 2005

(54) Positioning structure for power transmission mechanism

(76) Inventors: Jiro Iwasa, Kariya-shi (JP); Masahiro Kawaguchi, Kariya-shi (JP); Yasuharu Odachi, Kariya-shi (JP); Minoru Mera, Kariya-shi (JP); Kazuo Murakami, Kariya-shi (JP); Taku Adaniya, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 10/732,425

(22) Filed: Dec. 9, 2003

(51) Int. Cl. F16H 9/00; F16H 61/00

(52) U.S. Cl. 474/69

(57) ABSTRACT

A power transmission mechanism is attached to a housing of a rotary machine for inputting power to a rotary shaft of the rotary machine and includes a rotary body that is rotatably supported by the housing through a rotary body bearing and an electric motor, a stator of which is supported by the housing through a stator bracket. A positioning structure for the power transmission mechanism includes a bearing positioning means and a bracket positioning means. The bearing positioning means positions the rotary body bearing forward and rearward in an axial direction of the rotary shaft relative to the housing and has front and rear positioning surfaces. The bracket positioning means positions the stator bracket forward and rearward in the axial direction and has front and rear positioning surfaces. At least one of the front and rear positioning surfaces of the respective positioning means is shared with each other.

### BACKGROUND OF THE INVENTION

The present invention relates to a power transmission mechanism that is connected to a housing of a rotary machine for inputting power to a rotary shaft of the rotary machine and more particularly to a positioning structure for positioning the power transmission mechanism on the housing of the rotary machine.

A power transmission mechanism of such type is, for example, shown in FIG. 4 in which the power transmission mechanism is arranged in a power transmission path between a refrigerant compressor 101 of a vehicle air conditioner and an engine (not shown) for traveling a vehicle.

Namely, a boss 102a for a rotary shaft 104 extends from a housing 102 of the compressor 101. A pulley 105 is rotatably supported by the boss 102a through a bearing 113 for inputting power from the engine to the rotary shaft 104. A rotor 106a is supported by the rotary shaft 104 inside the pulley 105 so as to rotate integrally with the rotary shaft 104. A stator 106b is supported by the boss 102a inside the pulley 105 through a stator bracket 109. The rotor 106a and the stator 106b constitute the electric motor 106.

The bearing 113 is positioned in its axial direction by a first rear positioning surface 114 and a first front positioning surface 116a. The first rear positioning surface 114 is a wall surface of a step that is formed at the boss 102a on the rear side relative to the bearing 113 in the axial direction. The first front positioning surface 116a is a part of circular clip 16 that is fixedly fitted on the boss 102a on the front side relative to the bearing 113 in the axial direction.

The stator bracket 109 is positioned in its axial direction by a second rear positioning surface 110 and a second front positioning surface 112a. The second rear positioning surface 110 is a wall surface of another step that is also formed at the boss 102a on the rear side relative to the stator bracket 109 in the axial direction. The second front positioning surface 112a is another part of the circular clip 112 that is also fixedly fitted on the boss 102a on the front side relative to the stator bracket 109 in the axial direction. In summary, the bearing 113 and the stator bracket 109 are positioned in their axial direction by exclusive positioning means, respectively.

The positioning means for positioning the bearing 113 and the stator bracket 109 exclusively include the front positioning surfaces 112a, 116a and the rear positioning surfaces 110, 114 in the axial direction, respectively. Accordingly, the positioning structure (a mounting structure) for positioning the power transmission mechanism on the housing 102 of the compressor 101 becomes complicated so that various problems may occur.

Namely, for example, the positioning means for positioning the bearing 113 and the stator bracket 109 respectively need the circular clips 112, 116 so that the number of components and assembling processes increase for the compressor 101 with the power transmission mechanism. Also, the positioning means respectively require annular grooves 111, 115 for fitting the circular clips 112, 116 so that it is complicated to recess the annular grooves 111, 115 in the housing 102. Furthermore, the positioning means respectively require the steps (the rear positioning surfaces 110, 114) for positioning so that it is also complicated to form the steps in the housing 102.

Additionally, the exclusive positioning means for positioning the bearing 113 and the stator bracket 109 require relatively large displacement of the bearing is 113 and the stator bracket 109 in the axial direction, in view of a space for arranging the positioning means in the housing 102. Accordingly, there occurs a problem that the power transmission mechanism becomes large in size in its axial direction. Therefore, there is a need for simplifying a positioning structure for positioning a power transmission mechanism on a housing of a rotary machine.

### SUMMARY OF THE INVENTION

In accordance with the present invention, in a power transmission mechanism that is attached to a housing of a rotary machine for inputting power to a rotary shaft of the rotary machine, the power transmission mechanism includes a rotary body and an electric motor. The rotary body is rotatably supported by the housing through a rotary body bearing for transmitting power from an external drive source to the rotary shaft. A stator of the electric motor is supported by the housing through a stator bracket. The rotary shaft is optionally driven by the electric motor during stop of the external drive source. A positioning structure has a bearing positioning means and a bracket positioning means. The bearing positioning means positions the rotary body bearing forward and rearward in an axial direction of the rotary shaft relative to the housing of the rotary machine and has front and rear positioning surfaces. The bracket positioning means positions the stator bracket forward and rearward in the axial direction and has front and rear positioning surfaces. At least one of the front and rear positioning surfaces of the respective bearing positioning means and bracket positioning means is shared with each other.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal cross-sectional view of a compressor with a power transmission mechanism according to a preferred embodiment of the present invention;

FIG. 2 is a partially enlarged view of FIG. 1;

FIG. 3 is a cross-sectional view that is taken along the line I-I in FIG. 2; and

FIG. 4 is a partially enlarged cross-sectional view of a compressor with a conventional power transmission mechanism according to a prior art.

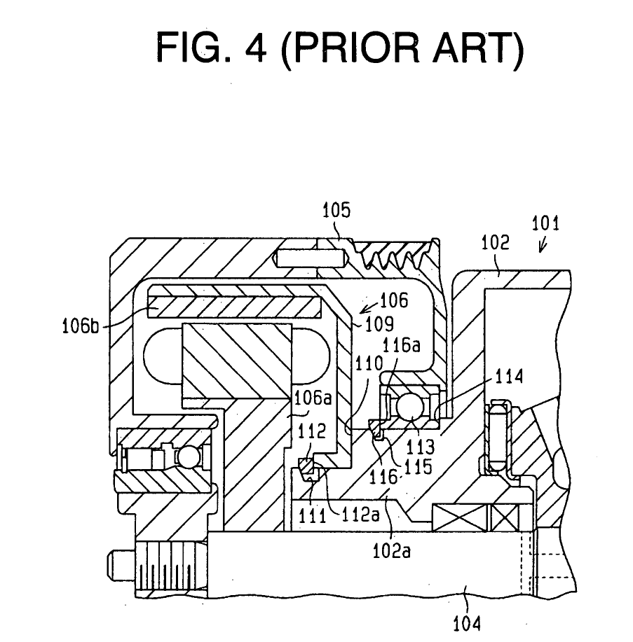

### DETAILED DESCRIPTION OF THE PREFERRED EMBODIMENTS

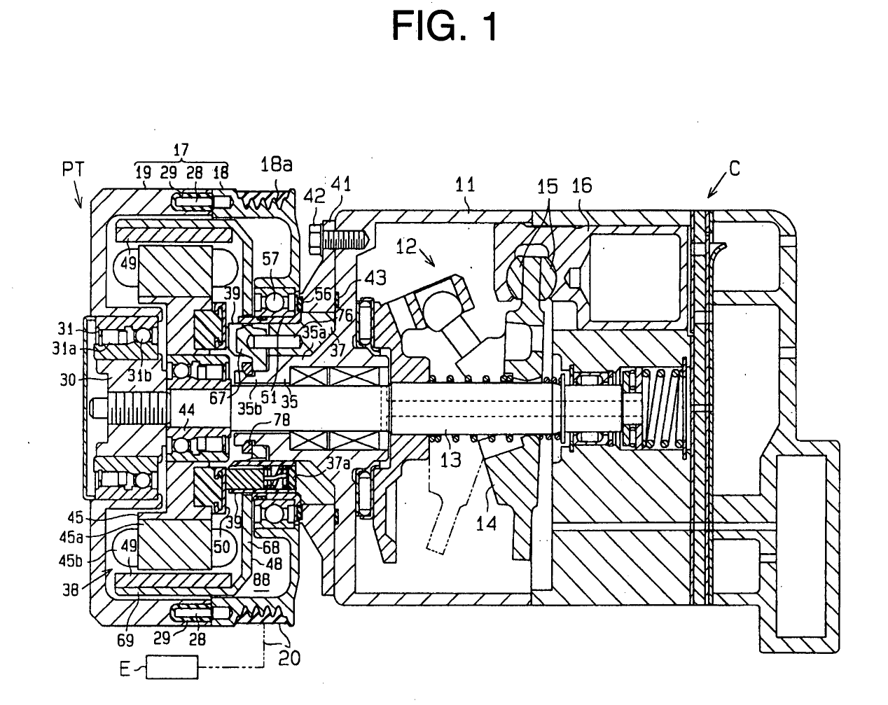

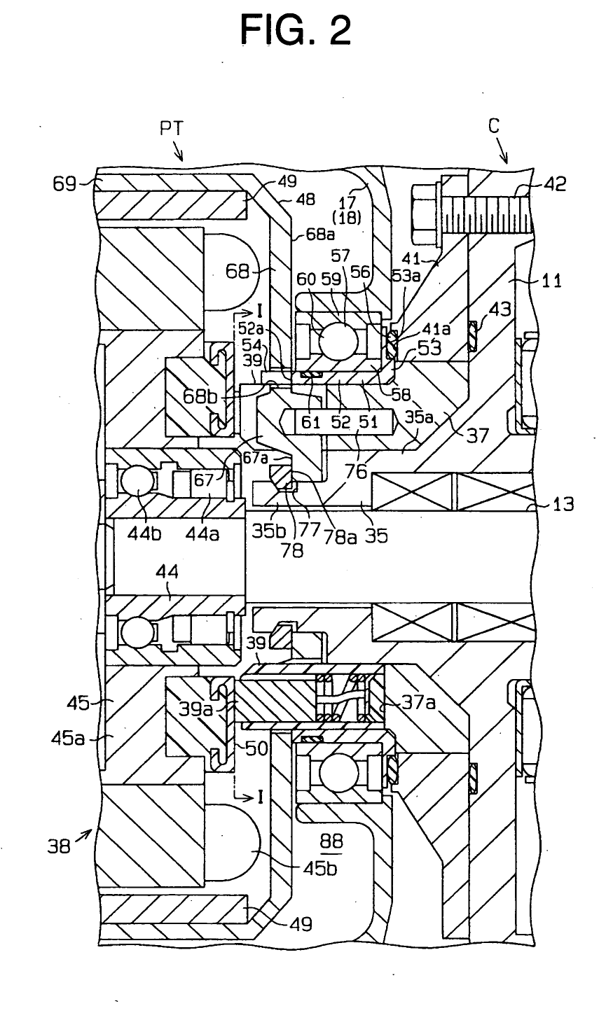

A preferred embodiment of the present invention will now be described with reference to FIGS. 1 through 3. The left side and the right side in FIGS. 1 and 2 respectively correspond to the front side and the rear side of a compressor C.

Now referring to FIG. 1, FIG. 1 illustrates a longitudinal cross-sectional view of the compressor C with a power transmission mechanism PT according to the preferred embodiment of the present invention. The refrigerant compressor C is a rotary machine for partially constituting a refrigeration cycle of a vehicle air conditioner. A housing 11 of the compressor C accommodates a piston type compression mechanism 12. The piston type compression mechanism 12 has a well-know structure in which the rotation of a swash plate 14 in accordance with the rotation of a rotary shaft 13 is converted to the reciprocation of a piston 16 is through a pair of shoes 15. Thus, refrigerant gas is compressed.

With respect to the compressor C, the power transmission mechanism PT is arranged coaxially with the rotary shaft 13 on the outside of the housing 11 for inputting power to the rotary shaft 13. The power transmission mechanism PT includes a pulley or a rotary body 17 and an electric motor 38 and is coupled to an engine or an external drive source E for traveling a vehicle. The pulley 17 is rotatably supported by the housing 11 and transmits power from the engine E to the rotary shaft 13. The electric motor 38 is, for example, utilized for driving the rotary shaft 13 when the engine E is stopped. The compressor C with the electric motor 38 is capable of air-conditioning (cooling) during the stop of the engine E.

The power transmission mechanism PT and a mounting structure for the power transmission mechanism PT to the compressor C will now be described.

Now referring to FIGS. 1 and 2, FIG. 2 illustrates a partially enlarged view of FIG. 1. The rotary shaft 13 of the compression mechanism 12 is rotatably supported by the housing 11. The front end of the rotary shaft 13 extends through the front end wall of the housing 11 and protrudes outside from the housing 11. A boss 35 for the rotary shaft 13 is integrally formed with the housing 11 and extends from the front end wall of the housing 11. The boss 35 forms a relatively large diameter portion 35a and a relatively small diameter portion 35b. The large diameter portion 35a is formed on the rear side (the proximal end of the boss 35), while the small diameter portion 35b is formed on the front side (the distal end of the boss 35).

A cylindrical brush unit holder 37 is fixedly fitted around the large diameter portion 35a of the boss 35. A power supply ring 41 is fixed to the radially outer side on the front wall surface of the housing 11 so as to surround the rear end of the brush unit holder 37. A first seal member 43 is interposed at an annular contact region between the front wall surface of the housing 11 and the power supply ring 41.

The pulley 17 includes an upstream pulley member 18 and a downstream pulley member 19. The upstream pulley member 18 forms a groove 18a at its outer circumferential surface for winding a belt 20 to be coupled with the engine E. The upstream pulley member 18 is rotatably supported by the brush unit holder 37 on the housing 11 through a pulley bearing or a rotary body bearing 57. The pulley bearing 57 is a ball bearing that includes an outside movable race 59 on the side of the upstream pulley member 18, an inside fixed race 58 on the side of the brush unit holder 37 and a rolling ball 60 (which is interposed between the inside fixed race 58 and the outside movable race 59).

The downstream pulley member 19 is supported by a hub 30 through a first one-way clutch 31. The hub 30 is fixedly connected to the front end of the rotary shaft 13. The upstream pulley member 18 is connected to the downstream pulley member 19 by a power transmission pin 28 and a rubber damper 29. The power transmission pin 28 functions as a breaking-type torque limiter. The rubber damper 29 moderates the variation of torque transmitted between the pulley members 18, 19.

The first one-way clutch 31 provides a clutch mechanism 31a and a bearing mechanism 31b. The clutch mechanism 31a permits power transmitted from the downstream pulley member 19 to the hub 30, while the clutch mechanism 31a disrupts power transmitted from the hub 30 to the downstream pulley member 19. Accordingly, as the upstream pulley member 18 is rotated in one direction by the operation of the engine E, the downstream pulley member 19 is also rotated in the same direction as the upstream pulley member 18 through the power transmission pin 28 and the rubber damper 29. This rotational power is input to the rotary shaft 13 through the first one-way clutch 31 and the hub 30.

On the contrary, as the rotary shaft 13 is rotated in the same direction by the electric motor 38 when the engine E is stopped, this rotational power is transmitted to the first one-way clutch 31 through the hub 30. However, the clutch mechanism 31a of the first one-way clutch 31 does not permit the power transmitted from the hub 30 to the downstream pulley member 19 so that the power of the electric motor 38 is prevented from being transmitted to the engine E, that is, the power generated by the electric motor 38 is prevented from being consumed by another operation other than the operation of the compression mechanism 12.

A sealed space 88 is defined inside the pulley 17 by connecting the upstream pulley member 18 and the downstream pulley member 19. The electric motor 38 is arranged coaxially with the pulley 17 in the sealed space 88.

Namely, a rotor 45 is connected to the rotary shaft 13 through a second one-way clutch 44 in the sealed space 88 of the pulley 17. The rotor 45 includes an iron core 45a and a coil 45b that is wound around the iron core 45a. A commutator 50 is fixedly connected to the rear end of the rotor 45. A stator 49 made of a magnet is arranged outside the rotor 45 in the sealed space 88. The stator 49 is supported by the housing 11 through a stator bracket 48.

A plurality of recesses 37a is formed on the front end of the brush unit holder 37 in the sealed space 88 of the pulley 17. The recesses 37a (only one of them shown in FIGS. 1 and 2) are formed around the axis of the pulley 17 at equiangular positions. Each of the recesses 37a holds a power supply brush unit 39. A brush 39a of the power supply brush unit 39 is pressed to contact the commutator 50. A wiring (not shown) is buried in the power supply ring 41 for externally supplying the brush 39a with electric power. Accordingly, the electric power is externally supplied to the coil 45b through the power supply ring 41 (the buried wiring), the power supply brush unit 39 and the commutator 50 so that the rotor 45 is rotated.

The second one-way clutch 44 includes a clutch mechanism 44a and a bearing mechanism 44b as well as the first one-way clutch 31. With respect to the rotation in one direction described for the first one-way clutch 31, the clutch mechanism 44a permits power transmitted from the rotor 45 to the rotary shaft 13, while the clutch mechanism 44a disrupts power transmitted from the rotary shaft 13 to the rotor 45. Accordingly, as the electric motor 38 is started during the stop of the engine E, the rotational power of the electric motor 38 is transmitted to the rotary shaft 13 through the second one-way clutch 44. On the contrary, even if the rotary shaft 13 is rotated by the operation of the engine E when the engine E is running, this rotational power is not input to the rotor 45. Thus, load for driving the rotor 45 by the engine E is reduced.

The positioning structure for positioning the pulley bearing 57 and the stator bracket 48 in the housing 11 will now be described.

As shown in FIG. 2, the radially outer surface of the front end of the brush unit holder 37 forms the recesses 37a so that the annular shape of the brush unit holder 37 is split. The power supply brush unit 39 is accommodated in each recess 37a to occupy the split spaces of the brush unit holder 37. A collar 51 is loosely fitted to cover a cylindrical surface, which is formed by the outer surface of the front end of the brush unit holder 37 and the outer surface of the power supply brush unit 39.

The collar 51 includes a cylindrical portion 52 and a flange 53. The cylindrical portion 52 is fitted around the brush unit holder 37 and the power supply brush unit 39. The flange 53 is provided at the rear end periphery of the cylindrical portion 52. The fixed race 58 of the pulley bearing 57 is press-fitted around the cylindrical portion 52 of the collar 51 and is pressed into in such a manner that the rear end surface of the fixed race 58 contacts the flange 53. A second seal member 61 is interposed at an annular contact region between the fixed race 58 and the cylindrical portion 52.

A rear surface 53a of the flange 53 of the collar 51 contacts an annular region of a front surface 41a of the power supply ring 41 through a third seal lo member 56. Namely, the front surface 41a of the power supply ring 41 contacts; the collar 51 to restrict the collar 51 from moving rearward in the axial direction of the rotary shaft 13. Thus, the front surface 41 a of the power supply ring 41 serves as a rear positioning surface 41a for positioning the pulley bearing 57 (the fixed race 58) in the axial direction.

The stator bracket 48 includes an annular proximal portion 67, an annular disc-shaped portion 68 and a cylindrical stator fixing portion 69 for fixing the stator 49. The disc-shaped portion 68 radially extends outward from the proximal portion 67. The stator fixing portion 69 extends forward from the outer periphery of the disc-shaped portion 68. The stator 49 is fixedly connected to the inner surface of the stator fixing portion 69. The proximal portion 67 of the stator bracket 48 is loosely fitted around the small diameter portion 35b of the boss 35. A pin 76 is interposed between the proximal -portion 67Sand the brush unit holder 37. The rotation of the stator bracket 48 is blocked by the pin 76 relative to the brush unit holder 37, that is, the housing 11.

An annular groove 77 is recessed in an outer circumferential surface of the small diameter portion 35b of the boss 35 on the front side relative to the proximal portion 67 of the stator bracket 48. A circular clip 78 is fitted in the annular groove 77. A front surface 67a of the proximal portion 67 of the stator bracket 48 contacts a rear surface 78a of the circular clip 78 at an annular contact region. In other words, the rear surface 78a of the circular clip 78 serves as a front positioning surface 78a that contacts the stator bracket 48 for restricting the forward movement of the stator bracket 48 in the axial direction of the rotary shaft 13.

A front end surface 52a of the cylindrical portion 52 of the collar 51 contacts the rear surface 68a of the disc-shaped portion 68 of the stator bracket 48. Accordingly, the forward movement of the collar 51 in the axial direction is directly restricted in such a manner that the front end surface 52a of the cylindrical portion 52 contacts the rear surface 68a of the disc-shaped portion 68 of the stator bracket 48. As a result, the front surface 67a of the proximal portion 67 of the stator bracket 48 is restricted by contacting the front positioning surface 78a of the circular clip 78. On the other hand, the rearward movement of the stator bracket 48 in the axial direction is directly restricted in such a manner that the rear surface 68a of the disc-shaped portion 68 contacts the front end surface 52a of the cylindrical portion 52 of the collar 51. As a result, the rear surface 53a of the flange 53 of the collar 51 is restricted by contacting the rear positioning surface 41a of the power supply ring 41 through the third seal member 56.

The circular clip 78 is a tapered circular clip and presses the proximal portion 67 of the stator bracket 48 rearward in the axial direction by being fitted in the annular groove 77. Accordingly, this pressing force is applied to the cylindrical portion 52 of the collar 51 through the disc-shaped portion 68 of the stator bracket 48, and the flange 53 of the collar 51 is pressed against the rear positioning surface 41a of the power supply ring 41 through the third seal member 56.

In the preferred embodiment, a means for positioning the pulley bearing 57 in the axial direction and a means for positioning the stator bracket 48 in the axial direction share both the front positioning surface 78a and the rear positioning surface 41a, which are components of the respective positioning means.

Incidentally, in the preferred embodiment, the collar 51 (the front end surface 52a), the stator bracket 48 (the rear surface 68a, the front surface 67a) and the circular clip 78 (the rear surface 78a) constitute a front bearing positioning means for positioning the pulley bearing 57 forward. The power supply ring 41 (the front surface 41a), the third seal member 56 and the collar 51 (the rear surface 53a) constitute a rear bearing positioning means for positioning the pulley bearing 57 rearward. The circular clip 78 (the rear surface 78a) is a front bracket positioning means for positioning the stator bracket 48 forward. Then, the power supply ring 41 (the front surface 41a), the third seal member 56 and the collar 51 (the rear surface 53a, the front end surface 52a) constitute a rear bracket positioning means for positioning the stator bracket 48 rearward.

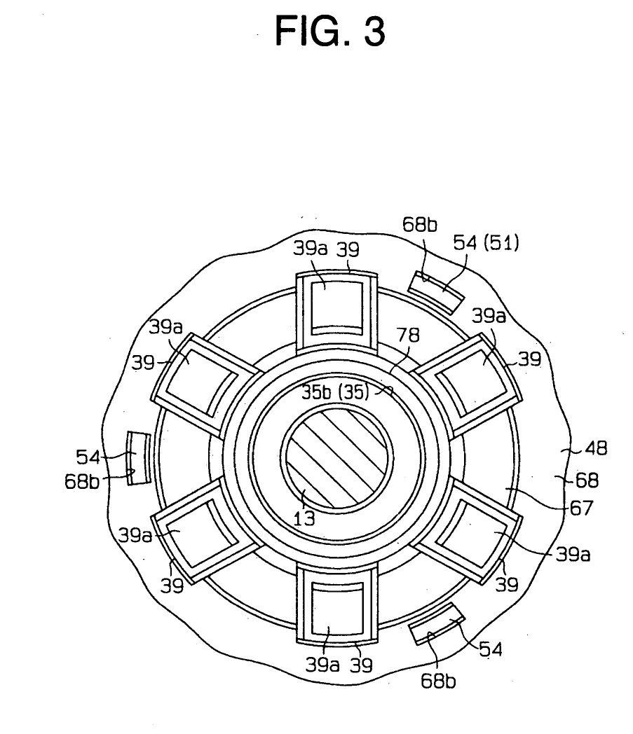

Now referring to FIGS. 2 and 3, FIG. 3 illustrates a cross-sectional view that is taken along the line I-I in FIG. 2. A plurality of engaging protrusions 54 extends forward from the front end surface 52a of the cylindrical portion 52. The engaging protrusions 54 are provided at equiangular positions along the circumferential direction of the cylindrical portion 52. Only one of the engaging protrusions 54 is shown in FIG. 2. Engaging holes or engaging recesses 68b are formed in the disc-shaped portion 68 of the stator bracket 48 so as to correspond with the engaging protrusions 54 of the collar 51.

The engaging protrusions 54 engage the engaging recesses 68b in such a manner that the pulley bearing 57 and the stator bracket 48 are positioned in their axial direction. Thereby, the collar 51 and the stator bracket 48, that is, the fixed race 58 and the housing 11, do not rotate around the axis of the pulley 17 relative to-each other. Namely, the engaging protrusions-54 and the engaging recess 68b constitute a rotation blocking means.

The following advantageous effects are obtained from the preferred embodiment.

(1) The positioning means for positioning the pulley bearing 57 and the positioning means for positioning the stator bracket 48 share the positioning surfaces 41a, 78a. Accordingly, the positioning structure (the mounting structure) 10 for the power transmission mechanism PT in the housing 11 of the compressor C becomes simple. As a result, the various problems due to the complicated positioning structure, such as the complicated machining, the increased number of components and the enlarged size of the power transmission mechanism PT in the axial direction, are solved.

(2) The positioning means for positioning the pulley bearing 57 and the positioning means for positioning the stator bracket 48 share both the front positioning surface 78a and the rear positioning surface 41a in the axial direction. This leads to a further simple positioning structure for the power transmission mechanism PT in the housing 11 of the compressor C.

(3) The circular clip 78, which exclusively serves as a positioning member, not only serves as the positioning means for positioning the pulley bearing 57 but also serves as the positioning means for positioning the stator bracket 48. The shared circular clip 78 for exclusively positioning results in reducing the number of components for the positioning structure so that the shared circular clip 78 largely contributes to providing the low-cost compressor C with the power transmission mechanism PT.

(4) The electric motor 38 is accommodated in the sealed space 88 that is defined inside the pulley 17. The pulley bearing 57 is arranged at a boundary between the sealed space 88 and the outside space. Water may be involved from the outside space into the sealed space 88 through a clearance between the collar 51 integrated with the pulley bearing 57 (the rear surface 53a of the flange 53) and the power supply ring 41 on the side of the housing 11 (the rear positioning surface 41a).

Then, in the preferred embodiment, the pulley bearing 57 contacts the rear positioning surface 41a through the third seal member 56, which shuts the water immersion path. Accordingly, the sealed space 88 has relatively high water resistance and protects the electric motor 38 from being immersed in water. Thus, as the third seal member 56 is arranged at the positioning portion of the pulley bearing 57, sealing pressure of the third seal member 56 is ensured by utilizing pressing force that acts at the positioning portion between the members 41 and 51 in comparison to a state where the third seal member 56 is separately arranged from the positioning portion, there is no need for assembling an additional exclusive member for ensuring sealing pressure of the third seal member 56 in the preferred embodiment.

(5) The rotation blocking means 54, 68b are arranged between the fixed race 58 of the pulley bearing 57 and the housing 11 for blocking the relative rotation between the members 11 and 58 around the axis of the pulley 17. Accordingly, the fixed race 58 is prevented from being rotated with the rotation of the pulley 17 so that, for example, the pulley bearing 57 is prevented from rattling due to the slide abrasion by the relative rotation between the fixed race 58 and the housing 11.

(6) The rotation blocking means 54, 68b is formed with the collar 51 and the engaging holes 68b. The collar 51 is fixedly fitted to the fixed race 58 of the pulley bearing 57 and forms the engaging protrusions 54 around the axis of the pulley 17. The engaging holes 68b are formed around the axis of the pulley 11 on the side of the housing 11. The collar 51 engages the side of the housing 11 with recess-protrusion engagement so as to block the relative rotation between the fixed race 58 and the housing 11. Thus, the collar 51 for forming the engaging protrusions or the rotation blocking means 54 is interposed between the pulley bearing 57 and the housing 11. Thereby, the pulley bearing 57 is not especially formed by, for example, directly forming the engaging protrusions 54 with the fixed race 58, but a general purpose bearing may still be used. This leads to providing the low-cost compressor C with the power transmission mechanism PT.

(7) With respect to the rotation blocking means 54, 68b, the engaging holes 68b on the side of the housing 11 are formed in the stator bracket 48. As described above, the pulley bearing 57 and the stator bracket 48 are positioned on the housing 11 so as to correspond with each other. Accordingly, while the pulley bearing 57 and the stator bracket 48 are positioned, the engaging protrusions 54 and the engaging holes 68b may be engaged with each other. As a result, the power transmission mechanism PT is easily assembled to the compressor C.

The present invention is not limited to the embodiment described above but may be modified into the following alternative embodiments.

In alternative embodiments to those of the above preferred embodiment, the positioning means for positioning the pulley bearing 57 and the positioning means for positioning the stator bracket 48 share only one of the front positioning surface 78a and the rear positioning surface 41a in the axial direction. For example, the stator bracket 48 is positioned rearward in the axial direction by a stepped wall surface at a boundary between the large diameter portion 35a and the small diameter portion 35b in the boss 35.

In alternative embodiments to those of the above preferred embodiment, the exclusive positioning member is not limited to the circular clip 78. For example, a screw recess is formed on the outer circumferential surface of the small diameter portion 35b in the boss 35, and a nut is screwed to this screw recess to provide a front positioning surface.

In alternative embodiments to those of the above preferred embodiment, the engaging recess is formed in the collar 51, while the engaging protrusion is formed on the stator bracket 48.

In alternative embodiments to those of the above preferred embodiment, the collar 51 and the brush unit holder 37, or the collar 51 and the power supply ring 41, are engaged with each other with recess-protrusion engagement to serve as the rotation blocking means.

In alternative embodiments to those of the above preferred embodiment, the engaging protrusion 54 is directly provided on the fixed race 58 of the pulley bearing 57.

In alternative embodiments to those of the above preferred embodiment, the collar 51 is fixedly press-fitted to the brush unit holder 37 and the power supply brush unit 39 to be integrated with these members 37, 39. This integration blocks the pulley bearing 57 (the fixed race 58) from rotating relative to the housing 11. In this state, the press-fit structure of the collar 51 relative to the brush unit holder 37 and the power supply brush unit 39 serves as the rotation blocking means.

In alternative embodiments to those of the above preferred embodiment, the collar 51 is omitted, and the pulley bearing 57 is directly fitted around the brush unit holder 37 and the power supply brush unit 39. In this state, the engaging protrusion 54 (the rotation blocking means) is directly provided on the fixed race 58 of the pulley bearing 57.

In the above preferred embodiment, the electric motor 38 is an inner rotor type, which arranges the rotor 45 inside the stator 49. In alternative embodiments to those of the above preferred embodiment, an electric motor is not limited to the inner rotor type but may employ an outer rotor type, which arranges a rotor outside a stator, or may employ a flat rotor type, which arranges a flat-shaped stator and a flat-shaped rotor in series in the axial direction.

Therefore, the present examples and embodiments are to be considered as illustrative and not restrictive, and the invention is not to be limited to the details given herein but may be modified within the scope of the appended claims.

1. A positioning structure for a power transmission mechanism that is attached to a housing of a rotary machine for inputting power to a rotary shaft of the rotary machine, the power transmission mechanism including a rotary body and an electric motor, the rotary body being rotatably supported by the housing through a rotary body bearing for transmitting power from an external drive source to the rotary shaft, a stator of the electric motor being supported by the housing through a stator bracket, the rotary shaft being optionally driven by the electric motor during stop of the external drive source, the positioning structure comprising:
a bearing positioning means for positioning the rotary body bearing forward and rearward in an axial direction of the rotary shaft relative to the housing of the rotary machine, the bearing positioning means having front and rear positioning surfaces; and
a bracket positioning means for positioning the stator bracket forward and rearward in the axial direction of the rotary shaft relative to the housing, the bracket positioning means having front and rear positioning surfaces, at least one of the front and rear positioning surfaces of the respective bearing positioning means and bracket positioning means being shared with each other.

2. The positioning structure according to claim 1, wherein both the front and rear positioning surfaces of the respective bearing positioning means and bracket positioning means in the axial direction are shared with each other.

3. The positioning structure according to claim 1, wherein at least one of the front and rear positioning surfaces in the axial direction is formed by a positioning member that is attached to the housing for exclusively positioning, the positioning surface formed by the positioning member being shared by the bearing positioning means and the bracket positioning means.

4. The positioning structure according to claim 3, wherein the exclusively positioning member is a tapered circular clip.

5. The positioning structure according to claim 1, wherein the electric motor is accommodated in a sealed space that is defined inside the rotary body, the rotary body bearing positioned at a boundary between the sealed space and an outside being in contact with the rear positioning surface for positioning the rotary body through a seal member for sealing the sealed space.

6. The positioning structure according to claim 1, further comprising:
a power supply ring fixedly connected to the housing, the power supply ring having the rear positioning surface for positioning the rotary body.

7. The positioning structure according to-claim 1, further comprising:
a rotation blocking means arranged between the fixed race of the rotary body bearing and the housing for blocking relative rotation therebetween around an axis of the rotary body.

8. The positioning structure according to claim 7, wherein the rotation blocking means includes an engaging protrusion and an engaging recess which are formed around the axis of the rotary body and are engaged with each other with recess-protrusion engagement, one of the engaging protrusion and engaging recess being integrally formed with a collar that is fixedly fitted to a fixed race of the rotary body bearing, the other of the engaging protrusion and engaging recess being provided on a side of the housing, the fixed race and the housing being blocked from rotating relative to each other.

9. The positioning structure according to claim 8, wherein one of the engaging protrusion and engaging recess provided on the side of the housing is formed on the stator bracket.

10. The positioning structure according to claim 1, wherein the rotary body is a pulley.

11. The positioning structure according to claim 1, wherein the rotary machine is a compressor.

12. The positioning structure according to claim 1, wherein the external drive source is an engine for traveling a vehicle.
